(19) United States
(12) Patent Application Publication
(10) Pub. No.: US 2017/0103723 A1
(43) Pub. Date: Apr. 13, 2017

(54) DISPLAY DEVICE AND DRIVING METHOD THEREOF

(71) Applicant: InnoLux Corporation, Jhu-Nan (TW)

(72) Inventors: Shao-Hong CHEN, Jhu-Nan (TW); Li-Wei SUNG, Jhu-Nan (TW); Po-Ju YANG, Jhu-Nan (TW)

(21) Appl. No.: 15/291,545

(22) Filed: Oct. 12, 2016

(30) Foreign Application Priority Data
Oct. 12, 2015 (CN) 201510656566.4

(51) Int. Cl. G09G 3/36

(52) U.S. Cl. CPC G09G 3/3688; G09G 3/3677; G09G 3/3696; G09G 2310/0251; G09G 2300/0823; G09G 2320/0247; G09G 2320/0209; G09G 2310/0213

(57) ABSTRACT

A display device and a driving method thereof are disclosed. A data driving circuit of the display device outputs data signals corresponding to data lines to sub-pixels. Two adjacent data signals of a first row sub-pixels of the sub-pixels are defined as a data signal pair, and the data signals of the first row sub-pixels are divided into a plurality of data signal pairs. The voltage polarity of each data signal pair is in a first or second arrangement. The first arrangement has a positive polarity of the data signal and a negative polarity of the data signal with respect to a common voltage in order, and the second arrangement has a negative polarity of the data signal and a positive polarity of the data signal with respect to the common voltage in order. A sequence of the voltage polarities of consecutive N data signals forms a cycle.

### CROSS REFERENCE TO RELATED APPLICATIONS

This Non-provisional application claims priority under 35 U.S.C. §119(a) on Patent Application No(s). 201510656566.4 filed in People's Republic of China on Oct. 12, 2015, the entire contents of which are hereby incorporated by reference.

### BACKGROUND

Technical Field

The present disclosure relates to a display device and a driving method thereof, and in particular, to a liquid crystal display device and a driving method thereof.

Related Art

With the advance of technology, flat display devices have been broadly applied to various fields and especially to liquid crystal display devices or organic light emitting diode display devices. Because flat display devices have superior characteristics of thin and light body, low power consumption, and no radiation, they gradually replace conventional cathode ray tube display devices and are applied to various electronic products, such as mobile phones, portable media devices, laptops, televisions, and so on.

Regarding to the liquid crystal display device, it is improper to apply a constant voltage to the liquid crystal molecule for a long time. If the liquid crystal molecule is applied with a constant voltage for a long time, the property of the liquid crystal molecule can be destroyed, which means the liquid crystal molecule will no longer be twisted or turned by the electric field to form the desired gray levels. Accordingly, the liquid crystal molecules must be driven periodically by the voltages of positive and negative polarities. In the display screen composed of a sub-pixel array arranged by a plurality of sub-pixels, it is unnecessary to drive the adjacent two sub-pixels by the voltages with the same polarity. The most common polarity arrays of the liquid crystal panel include frame inversion, column inversion, row inversion and dot inversion.

The dot inversion, which has a property that the polarity of each sub-pixel is different from the polarities of the adjacent upper sub-pixel, the adjacent below sub-pixel, the adjacent left sub-pixel and the adjacent right sub-pixel, can obviously reduce the crosstalk and flicker of images so as to provide a better display quality. However, in the row inversion and dot inversion, the voltage polarities of data signals provided by each of the data lines must be sufficiently changed (from positive polarity to negative polarity or from negative polarity to positive polarity), so the row inversion and dot inversion have higher power consumption than the column inversion. On the contrary, the frame inversion has lower power consumption, but it has serious flicker issue, which causes a poor display quality,

Therefore, it is desired to provide a display device and a driving method thereof that have lower power consumption and good display quality.

### SUMMARY

In view of the foregoing, an objective of the present disclosure is to provide a display device and a driving method that have lower power consumption and are capable of improving the flicker, crosstalk and display greenish of a specific image.

To achieve the above, the present disclosure discloses a display device, which includes a display panel, a plurality of scan lines, a plurality of data lines, a scan driving circuit and a data driving circuit. The display panel has a plurality of sub-pixels. The data lines are intersected with the scan lines to define the sub-pixels, the sub-pixels comprise a first row sub-pixels. The scan driving circuit is electrically coupled with the scan lines, and the data driving circuit is electrically coupled with the data lines. The data driving circuit outputs a plurality of data signals through each of the data lines to the sub-pixels, respectively. Two adjacent data signals of the first row sub-pixels are defined as a data signal pair, and the plurality of data signals of the first row sub-pixels are divided into a plurality of data signal pairs of the first row sub-pixels. The voltage polarity of each data signal pair is in a first arrangement or a second arrangement. The first arrangement has a positive polarity of the data signal and a negative polarity of the data signal in order with respect to a common voltage. The second arrangement has a negative polarity of the data signal and a positive polarity of the data signal in order with respect to the common voltage. A sequence of voltage polarities of consecutive N data signals forms a cycle. Wherein, N is an even number greater than or equal to 10, and an amount of the first arrangement or the second arrangement in the cycle is greater than or equal to 1 and less than or equal to (N/2−1).

To achieve the above, the present disclosure also discloses a driving method of a display device. The display device includes a display panel, a plurality of scan lines, a plurality of data lines, a scan driving circuit and a data driving circuit. The display panel has a plurality of sub-pixels, the sub-pixels comprise a first row sub-pixels. The data lines intersect with the scan lines to define the sub-pixels. The driving method includes the following steps of: conducting the scan lines in order by the scan driving circuit; and outputting a plurality of data signals through the data lines by the data driving circuit to drive the sub-pixels. Wherein, adjacent two of data signals of the first row sub-pixels are defined as a data signal pair, and the plurality of data signals of the first row sub-pixels are divided into a plurality of data signal pairs of the first row sub-pixels. The voltage polarity of each of data signal pair is in a first arrangement or a second arrangement. The first arrangement has a positive polarity of the data signal and a negative polarity of the data signal in order with respect to a common voltage. The second arrangement has a negative polarity of the data signal and a positive polarity of the data signal in order with respect to the common voltage. A sequence of the voltage polarity of consecutive N data signals forms a cycle. Wherein, N is an even number greater than or equal to 10, and an amount of the first arrangement or the second arrangement in the cycle is greater than or equal to 1 and less than or equal to (N/2−1).

In one embodiment, one of the data lines outputs a plurality of data signals with the same voltage polarity (with respect to the common voltage) in a frame time.

In one embodiment, in a first frame time, one of the sub-pixels accepts a first data signal with a first voltage polarity, in a second frame time, the one of the sub-pixels accepts a second data signal with a second voltage polarity, wherein the second frame time is close to the first frame time, and the first voltage polarity is opposite to the second voltage polarity.

In one embodiment, the sub-pixels are arranged in a flip sub-pixel array.

In one embodiment, the display device further includes a memory electrically coupled with the display panel for storing the sequence of the voltage polarities of the consecutive N data signals in the cycle.

In one embodiment, the driving method is further applied with a charge sharing function.

In one embodiment, the driving method is further applied with a scan pre-charge function.

As mentioned above, in the display device and driving method thereof of the disclosure, the data driving circuit outputs a plurality of data signals through the data lines to the sub-pixels. In spatial, two adjacent data signals of the first row sub-pixels are defined as a data signal pair, and the plurality of data signals of the first row sub-pixels are divided into a plurality of data signal pairs of the first row sub-pixels. The voltage polarity of each data signal pair is in a first arrangement or a second arrangement. Wherein, the first arrangement has a positive polarity of the data signal and a negative polarity of the data signal in order with respect to a common voltage, while the second arrangement has a negative polarity of the data signal and a positive polarity of the data signal in order with respect to the common voltage. A sequence of the voltage polarities of N consecutive data signals forms consecutive N/2 data signal pairs, and the consecutive N/2 data signal pairs form a cycle. Wherein, N is an even number greater than or equal to 10, and the amount of the first arrangement or the second arrangement in the cycle is greater than or equal to 1 and less than or equal to (N/2−1). Compared with the conventional art, the display device of the disclosure utilizes an irregular polarity arrangement instead of the conventional column inversion, which provides a regular arrangement of positive and negative voltage polarity for the adjacent data signals. This change can improve the coupling level of the pixel electrodes and the common electrodes. Accordingly, the display device can have lower power consumption and improve the undesired display phenomenon such as flicker, crosstalk or display greenish.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1 is a schematic diagram showing a liquid crystal display device, which displays a specific image;

FIG. 2A is a schematic diagram showing a display device according to an embodiment of the present disclosure;

FIG. 2B is a schematic diagram showing the voltage polarities of the data signals outputted from the data driving circuit of the display device of FIG. 2A;

FIG. 3A is a schematic diagram showing a part of scan lines, data lines and sub-pixels of a display device according to another embodiment of the disclosure;

FIG. 3B is a schematic diagram showing the display device of FIG. 3A, which displays a specific image (V-stripe); and

FIG. 4 is a flow chart of a driving method of a display device according to an embodiment of the disclosure.

### DETAILED DESCRIPTION OF THE INVENTION

The embodiments of the disclosure will be apparent from the following detailed description, which proceeds with reference to the accompanying drawings, wherein the same references relate to the same elements.

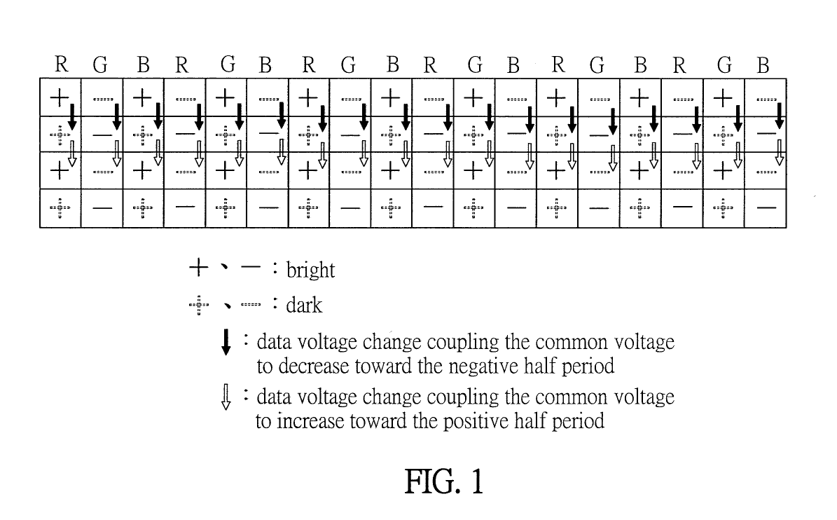

FIG. 1 is a schematic diagram showing a liquid crystal display device, which displays a specific image. In the liquid crystal display device of FIG. 1 (column inversion), one data line outputs a plurality of data signals with the same voltage polarity (with respect to the common voltage) in order within a frame time. In more detailed, regarding to one of the data lines, the data signals of the same voltage polarity are sent to the sub-pixels connected to this data line within a frame time, so that the liquid crystal display device has lower power consumption.

As shown in FIG. 1, in a specific image displayed by the display device, the consecutive sub-pixels show bright, dark (the sub-pixel is turned off), bright, dark and so on, which is also called a sub-pixel on-off pattern or dot on-off pattern. Herein, R represent red, G represent green, and B represent blue. When a scan line connects to a first row is turned on, the thin film transistors of the sub-pixels corresponding to the first row are turned on. Accordingly, when the data lines provide the data signals to the pixel electrodes of the sub-pixels corresponding to the first row, the voltage polarities of the first row are “+−+−+− . . . ” When the scan line connects to a second row is turned on, the thin film transistors of the sub-pixels corresponding to the second row are turned on. Accordingly, when the data lines provide the data signals to the pixel electrodes of the sub-pixels corresponding to the second row, the voltage polarities of the second row of are also “+−+−+− . . . ”.

With considering a red sub-pixel (R) of the first row of first column (bright) and a red sub-pixel (R) of the second row of first column (dark), since the data signals provided by the data line connecting to the sub-pixels of the first column are a voltage with a positive polarity, the data line will couple the common electrode corresponding to the red sub-pixel at the second row of first column. This coupling will cause the decrease of the voltage of the common electrode bias toward the negative half period. Similarly, with considering a green sub-pixel (G) of the first row of second column (dark) and the second row of second column (bright), since the data signals provided by the data line connecting to the sub-pixels of the second column have a voltage with a negative polarity, the data line will couple the common electrode corresponding to the green sub-pixel at the second row of second column (bright). This coupling will also cause the decrease of the voltage of the common electrode bias toward the negative half period. Accordingly, at the moments of the voltage changes of the data signals between the first row and second row, the coupling phenomenon between the data line and the common electrode will result in the voltage of the common electrode bias toward the negative half period, thereby leading the voltage driving the liquid crystal of the sub-pixel of the second row to be incorrect. Similarly, the voltage changes of the data signals between the m and (m+1) rows also have the same effect to the common electrode, and the detailed description will be omitted.

Besides, with considering the red sub-pixels (R) of the second row of first column (dark) and a red sub-pixels (R) of the third row and first column (bright), since the data signals provided by the data line connecting to the sub-pixels of the first column have a voltage with a positive polarity, the data line will couple to the common electrode at the moment of voltage change of the data signal, the voltage of the data signal provided to the second row is changed when the data signal provided to the third row(switching of charging and discharging), This coupling will cause the increase of the voltage of the common electrode bias toward the positive half period. Similarly, with considering the green sub-pixels (G) of the second row of second column (bright) and a green sub-pixels (G) of the third row of second column (dark), since the data signals provided by the data line connecting to the sub-pixels of the second column are negative voltage, the data line will couple to the common electrode at the moment of voltage change of the data signal, the voltage of the data signal provided to the second row is changed when the data signal provided to the third row(switching of charging and discharging). This coupling will also cause the voltage of the common electrode bias toward the positive half period, thereby leading the voltage driving the liquid crystal of the sub-pixel of the second row to be incorrect. Similarly, the voltage changes of the data signals between the (m+1) and (m+2) rows also have the same effect to the common electrode, and the detailed description will be omitted.

In other words, the coupling level of the pixel electrode and the common electrode is unbalanced at the moment that the data voltages between the adjacent sub-pixels change, so that the voltage used to drive the liquid crystal is incorrect, which results in the undesired phenomenon such as flicker, crosstalk, and the likes.

In order to make the display device have lower power consumption and improve the undesired phenomenon of the displayed specific image, a display device and a driving method thereof according to an embodiment of the disclosure will be described hereinafter with reference to the related drawings.

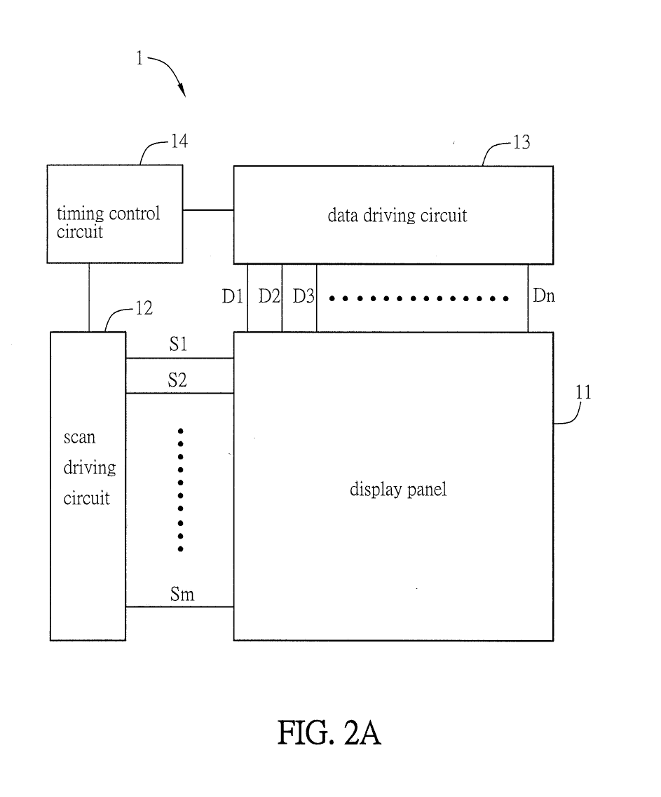

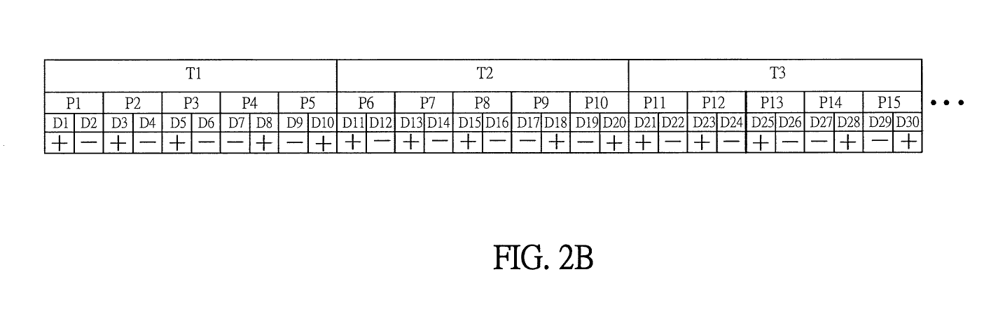

FIG. 2A is a schematic diagram showing a display device 1 according to an embodiment of the present disclosure, and FIG. 2B is a schematic diagram showing the voltage polarities of the data signals outputted from the data driving circuit 13 of the display device 1 of FIG. 2A. The display device 1 of this embodiment can be an IPS (in-plane switch), FFS (fringe field switching), TN (twisted nematic), or VA mode (vertical alignment mode) liquid crystal display device, and this invention is not limited.

The display device 1 includes a display panel 11, a plurality of scan lines S1˜Sm, a plurality of data lines D1˜Dn, a scan driving circuit 12, a data driving circuit 13 and a timing control circuit 14.

The display panel 11 is a liquid crystal display panel having a plurality of sub-pixels (not shown). The data lines D1˜Dn and the scan lines S1˜Sm are intersected to form the sub-pixels. In addition, the scan driving circuit 12 is electrically coupled with the scan lines S1˜Sm, and the data driving circuit 13 is electrically coupled with the data lines D1˜Dn. The data driving circuit 13 outputs a plurality of data signals through the data lines D1˜Dn to the sub-pixels. The timing control circuit 14 transmits a vertical sync signal and a horizontal sync signal to the scan driving circuit 12, transforms the video signals received from outside to generate the data signals to the data driving circuit 13, and then transmits the data signals and the horizontal signal to the data driving circuit 13. In addition, the scan driving circuit 12 turns on the scan lines S1˜Sm in order based on the vertical sync signal. In one frame time, when the scan lines S1˜Sm are turned on in order, the data driving circuit 13 transmits the pixel voltage signals to the pixel electrodes of the sub-pixels through the data lines D1˜Dn. Accordingly, the display device 1 can display an image.

In this embodiment, the data driving circuit 13 of the display device 1 outputs the data signals by the following inversion mode: one data line outputs a plurality of data signals with the same voltage polarity (with respect to the common voltage) in order in one frame time. Accordingly, the power consumption of the display device 1 can be reduced. In one sub-pixel, the voltage polarities of the data signals in two consecutive frame times are opposite.

As shown in FIG. 2B, adjacent two of data signals (or data lines) of a first row sub-pixels are defined as a data signal pair, and the data signals of the first row sub-pixels are divided into a plurality of data signal pairs of the first row sub-pixels. The voltage polarities of the two spatially adjacent data signals of each data signal pair are opposite. For example, if there are totally 240 (n) data lines, it will be correspondingly 240 data signals corresponding to a specific row. The data signal of the data line D1 and the data signal of the data line D2 corresponding to the specific row are defined as a data signal pair P1. The data signals of the date lines D3 and D4 corresponding to the specific row are defined as a data signal pair P2, and so on. Accordingly, 240 data signals corresponding to the specific row can be divided into 120 data signal pairs P1˜P120, and the voltage polarities of the two data signals of each data signal pair are opposite. That is, the voltage polarities of two spatially adjacent data signals of each data signal pair are in either a first arrangement or a second arrangement. In the first arrangement, the two data signals include a positive polarity of the data signal and a negative polarity of the data signal in order with respect to the common voltage. In the second arrangement, the two data signals include a negative polarity of the data signal and a positive polarity of the data signal in order with respect to the common voltage.

In a row, a sequence of the voltage polarities of consecutive N data signals of the first row sub-pixels forms a cycle. Wherein, N is an even number, which is greater than or equal to 10. N is less than or equal to the total amount of the data signals (lines). In this embodiment N is less than or equal to 240. In other words, in one row of sub-pixels, the sequence of the voltage polarities of the data signals in one cycle are identical to a sequence of the voltage polarities of the data signals in the previous cycle or next cycle. For example, the sequence of the voltage polarities of the data signals of a cycle T2 is identical to the sequence of the voltage polarities of the data signals of a cycle T1. As shown in FIG. 2B, in one row with 10 sub-pixels (N=10), 5 consecutive data signal pairs is defined as a cycle (e.g. the data signal pairs P1˜P5 is a cycle T1, the data signal pairs P6˜P10 is a cycle T2, and so on (totally 24 cycles)), and the voltage polarities of 10 data signals of the cycle T1 are identical to that of 10 data signals of the cycle T2 or any of other cycles. To be noted, if the amount of total data lines is not a multiple of N, it is possible to generate several virtual data signals to compensate the latest cycle. For example, if there are 6 data signals remained, it is to generate 4 virtual data signals to make the latest cycle with 10 data signals. Of course, the remained data signals can also be processed by other approaches, and the invention is not limited.

As mentioned above, the voltage polarities of the two data signals of each data signal pair corresponding to two spatially adjacent sub-pixel of a row are in a first arrangement or a second arrangement. The amount of the first or second arrangement is greater than or equal to 1 and is less than or equal to (N/2−1). For example, when N=10, 1≦the amount of the first or second arrangement ≦4(4=N/2−1). Furthermore, the sum of the amount of the first arrangement and second arrangement is (N/2). In this case, as shown in FIG. 2B, the data signal pairs P1, P2 and P3 are in the first arrangement, and the data signal pairs P4 and P5 are in the second arrangement. Thus, the amount of the first arrangement is 3, and the amount of the second arrangement is 2. To be noted, the first and second arrangements can be repeated irregularly and the amount of the first arrangement and the amount of the second arrangement is different. In addition, in one embodiment, the display device 1 further includes a memory (not shown), which is used to store the sequence of voltage polarities of the N data signals in the cycle.

Regarding to the liquid crystal display device with conventional column inversion, in a row, the voltage polarities of the data signals for driving the sub-pixels are spatially in a periodical arrangement of positive and negative polarities one by one, and the data signals are also in the periodical arrangement of positive and negative polarities one by one. Accordingly, when the display device with column inversion displays the specific image as shown in FIG. 1, the coupling level of the pixel electrode and the common electrode is unbalance at the moment of switching of charging and discharging, so the spatially adjacent two rows of sub-pixels will have the undesired phenomenon such as flicker, crosstalk, or the likes. Different from the above case with periodical arrangement, the display device 1 of this embodiment uses an irregular arrangement of the positive and negative polarities of the data signals for improving the coupling level of the pixel electrode and the common electrode. Accordingly, the increase of the voltage of the common electrode bias toward the positive half period and the decrease of the voltage of the common electrode bias toward the negative half period are close to each other, thereby improving the flicker and crosstalk. If N is larger, the improvement of the crosstalk is better. Thus, the display device 1 can output the data signals with the same voltage polarities (with respect to the common voltage) through one data line within a frame time, which is capable of lowering the power consumption and improving the flicker and crosstalk of the specific image.

In practice of one embodiment, the first step is to generate a random sequence corresponding to the (N/2) data signal pairs in each cycle, and the step is to determine the voltage polarity sets by the first arrangement (+,−) or the second arrangement (−,+) corresponding to the sequence. In above-mentioned case, the first step is to generate 5 random numbers (corresponding to 5 data signal pairs). If the random number is an odd number, the voltage polarities of the corresponding data signal pair is in the first arrangement (+,−). On the contrary, if the random number is an even number, the voltage polarities of the corresponding data signal pair is in the second arrangement (−,+). Accordingly, the voltage polarities of the N data signals in every cycle can be determined by the above method, but this invention is not limited to this.

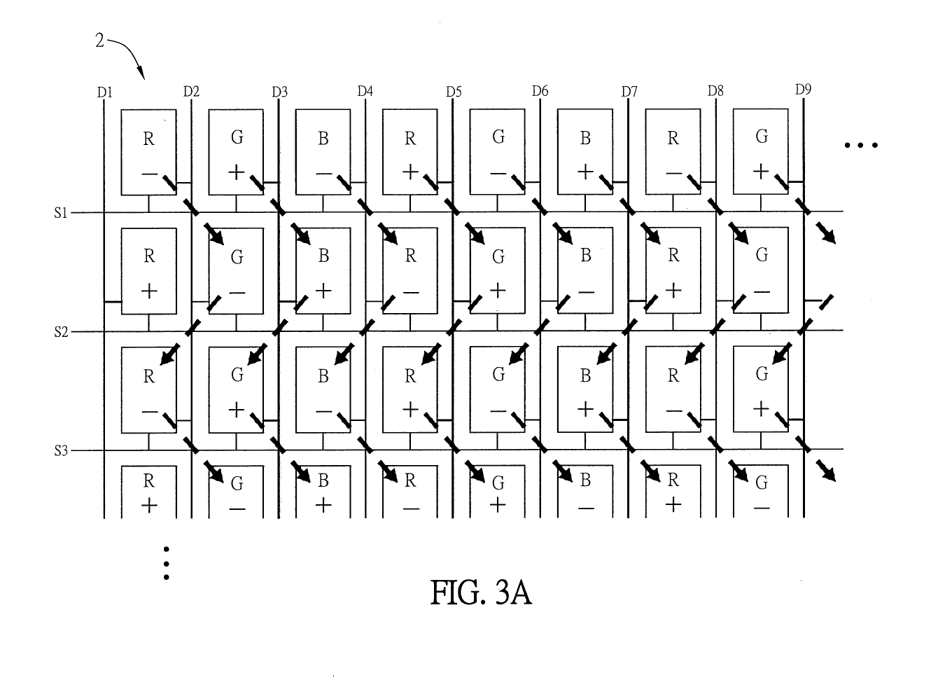

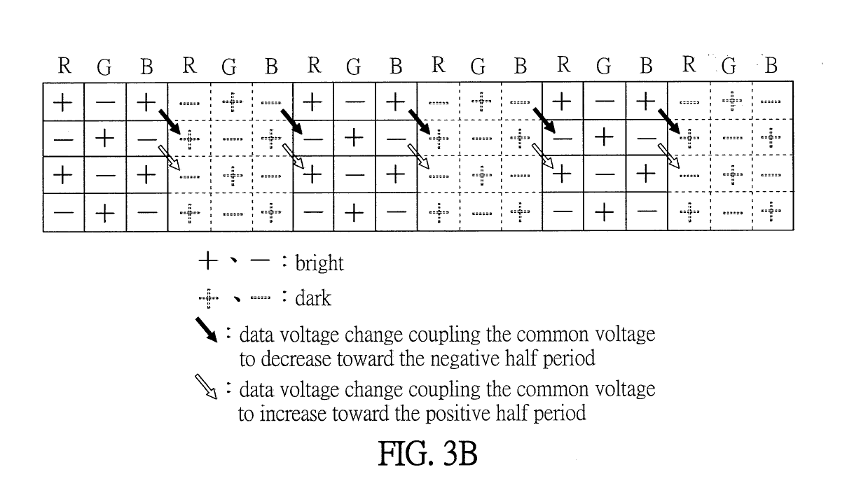

FIG. 3A is a schematic diagram showing a part of scan lines S1˜S3, a part of data lines D1˜D9, and the corresponding sub-pixels of a display device 2 according to another embodiment of the disclosure, and FIG. 3B is a schematic diagram showing the display device 2 of FIG. 3A, which displays a specific image (V-stripe).

Similar to the display device 1 of FIG. 2A, the display device 2 also includes a display panel, a plurality of scan lines, a plurality of data lines, a scan driving circuit, a data driving circuit and a timing control circuit 14 (not shown). The technical features thereof can be referred to the above embodiment, so the detailed description thereof will be omitted. The voltage polarity inversion mode of the data signals outputted from the data driving circuit of the display device 2 of this embodiment within one frame time is to output a plurality of data signals with the same voltage polarity (with respect to the common voltage) in order through one data line. However, the sub-pixels of the display device 2 arranged in flip pixel array. As shown in FIG. 3A, the display device 2 has a flip pixel array, so that one data line is alternately connecting the sub-pixels in two adjacent columns for alternately charging or discharging the sub-pixels disposed at two sides of the data line. For example, when the scan line Si is turned on, the data line D2 provides a data signal with negative polarity (with respect to the common voltage) to the red sub-pixel (R) located at the left side of the data line D2 (first row of first column). Next, when the scan line S2 is turned on, the data line D2 provides a data signal with negative polarity (with respect to the common voltage) to the green sub-pixel (G) located at the right side of the data line D2 (second row of second column). Afterwards, when scan line S3 is turned on, the data line D2 provides a data signal with negative polarity (with respect to the common voltage) to the red sub-pixel (R) located at the left side of the data line D2 (third row of first column), and so on. Accordingly, the data line D2 continuously provides data signals with negative polarity within one frame time, and the sub-pixels can be driven as a result just like the conventional dot inversion case. Besides, this embodiment can obviously decrease the flicker and crosstalk phenomenon. As a result, the display device 2 has lower power consumption and better display quality.

When displaying a V-stripe, as shown in FIG. 3B, the display device 2 displays a specific image including three columns of bright sub-pixels, three columns of dark sub-pixels, and so on periodically, which also called a V-stripe. The following description will take a normally black IPS liquid crystal driving method and flip pixel array structure as an example. Wherein, the normally black means the transmittance of the display device is at minimum as the liquid crystals are not applied with voltages. In this case, the polarity of common voltage of the common electrode coupled by the data voltage is opposite to the voltage polarity of the green sub-pixel (G), but is the same as the voltage polarities of the red sub-pixel (R) and the blue sub-pixel (B). When the coupling direction is increased toward the positive half period, the voltage polarity of the green sub-pixel (G) is “−”, so the cross voltage of the green sub-pixel is increased; the voltage polarity of the red sub-pixel (R) and the blue sub-pixel (B) is “+”, so the cross voltage of the red sub-pixel and blue sub-pixel is decreased. Otherwise, when the coupling direction is decrease toward the negative half period, the voltage polarity of the green sub-pixel (G) is “+” and the voltage polarities of the red sub-pixel (R) and the blue sub-pixel (B) is “−”. Accordingly, the cross voltage of the green sub-pixel (R) is increased, and the cross voltages of the red sub-pixel (R) and the blue sub-pixel (B) are decreased. This will cause the greenish of the displayed image.

The coupling phenomenon as the display device 2 displays the specific image (V-stripe) will be further described hereinafter. Taking the blue sub-pixel (B, bright) of the first row of third column and the red sub-pixel (R, dark) of the second row of fourth column as an example. At the moment of data voltage change between the first row and second row, the sub-pixel of the second row of fourth column and the sub-pixel of the first row of third column are connected to the same data line, so the voltage of the common electrode provided to the sub-pixel of the second row of fourth column (dark) decreases toward the negative half period due to the coupling between the common electrode and the pixel electrode of the sub-pixel of the first row of third column (bright). Similarly, taking the blue sub-pixel (B, dark) of the first row of sixth column and the red sub-pixel (R, bright) of the second row of seventh column as an example. Since the sub-pixel of the first row of sixth column and the sub-pixel of the second row of seventh column are connected to the same data line, the common electrode provided to the sub-pixel of the second row of seventh column (bright) decreases toward the negative half period due to the coupling between the common electrode and the pixel electrode of the sub-pixel of the first row of sixth column (dark), This will cause the incorrect of the cross voltage of the liquid crystals. Accordingly, at the moment of data voltage change between the first and second rows, the common voltage of the sub-pixels located at the border between the bright zone and dark zone will be decreased toward the negative half period due to the coupling phenomenon, thereby causing the incorrect cross voltage of the liquid crystals. Besides, since the voltage of the common electrode is decreased toward the negative half period, the cross voltage, between the pixel electrode and common electrode, provided to the red and blue sub-pixels is reduced. For example, if the original pixel voltage is −5V and the original common voltage is 0V, the cross voltage is 5V. However, in the case that the voltage of the common electrode decreases toward the negative half period, the voltage of the common electrode becomes −0.5V, so the actual cross voltage becomes 4.5V. This will result in the red and blue sub-pixels a little darker. Otherwise, the cross of the pixel electrode and common electrode for the green sub-pixel is increased. For example, if the original pixel voltage is +5V and the original common voltage is 0V, the cross voltage is 5V. However, in the case that the voltage of the common electrode decreases toward the negative half period, the voltage of the common electrode becomes −0.5V, so the actual cross voltage becomes 5.5V. This will result in the green sub-pixel a little brighter, and the entire image has greenish phenomenon.

Similarly, the common voltage of the sub-pixels located at the border between the bright zone and dark zone will be increased toward the positive half period due to the coupling phenomenon at the moment of data voltage change between the second and third rows, thereby causing the incorrect cross voltage of the liquid crystals. In other words, the displayed image is unbalance at the moment of data voltage change of the sub-pixels located at the border between the bright and dark zones, which will lead to the undesired display phenomenon such as greenish.

The display device 2 includes a data driving circuit to output a plurality of data signals corresponding to the data lines for driving the sub-pixels. The technical features of the driving method are the same those of the display device 1, so the detailed description will be omitted.

Regarding to the display device 2 with the FHD resolution (1920×1080), when the display device 2 displays a V-stripe, every 6 sub-pixels are defined as a set, so the amount of sub-pixels with positive polarity is more than the amount of sub-pixels with negative polarities by 1 in the set. Accordingly, the total amount of sub-pixels with positive polarity is greater than the total amount of sub-pixels with negative polarity by 1920× 3/6=960. If a cycle includes N data signals, the total amount of positive polarities is greater than the total amount of negative polarities by M when displaying V-stripe. The different random arrangements (the amounts of the first and second arrangements are random) can correspond to different M values. Accordingly, in a display image, the total amount of sub-pixels with positive polarity will be greater than the total amount of sub-pixels with negative polarity by (1920×3)×(M/N). As a result, when N is greater, the amounts of sub-pixels with the positive polarity and the amounts of sub-pixels with negative polarity are closer, so that the greenish phenomenon can be sufficiently improved. In addition, since the first and second arrangements are irregularly arranged, the greenish phenomenon will be improved with comparing to the conventional driving arrangement as (M/N) is less than ⅙.

As mentioned above, the display device 2 of this embodiment has the following properties: (a) capable of improving the undesired phenomenon such as flicker, crosstalk or greenish when displaying a specific image; (b) achieving lower power consumption by outputting a plurality of data signal with the same voltage polarity (with respect to the common voltage) by one data line within a frame time; (c) achieving the goal of power saving by applying with the charge sharing function; (d) providing the sub-pixels with better charging and discharging conditions (the voltage level of the sub-pixels is more precise) by applying with the scan pre-charge function; (e) reducing the complex calculations by not to consider the voltage polarity arrangement of the previous or current frame; (f) the driving circuit (IC) may include a memory (e.g. RAM) to store a set of random sequence, which including (N/2) numbers, wherein N is greater than and equal to 10 (the memory can store the arrangement of the (N/2) data signal pairs in the cycle), and the random sequence can be written and set by external components; (g) a code generator is not needed for generating the random signals; (h) the driving circuit (IC) needs a multiplexer to transform the random sequence into the first arrangement (+,−) or the second arrangement (−,+) of the voltage polarity signals; (i) the voltage polarity signals of (h) is combined with the data driving circuit to determine the output voltage of each data line; (j) the voltage polarities of the data signals of one data line are the same within a frame, but the voltage polarities of one sub-pixel are opposite in adjacent frames. For example, the voltage polarities of one sub-pixel in the current and previous frames or in the current and next frames are opposite.

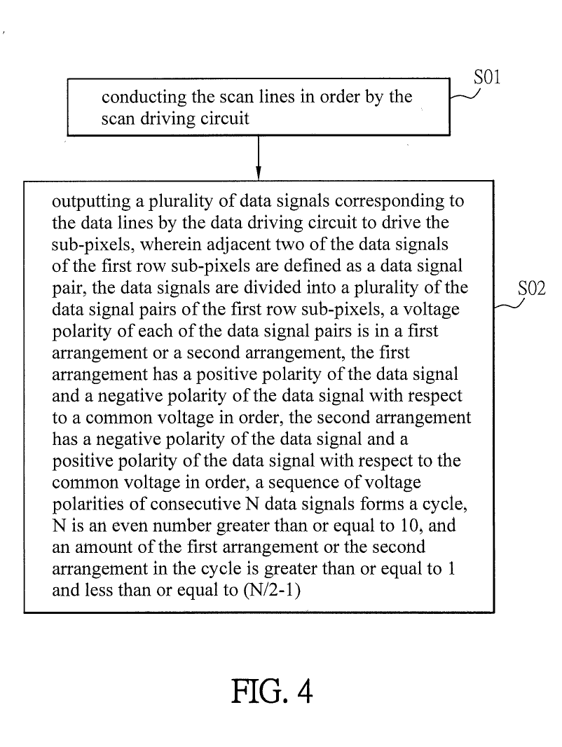

FIG. 4 is a flow chart of a driving method of a display device according to an embodiment of the disclosure. The driving method of a display device according to the embodiment of the disclosure will be described hereinafter with reference to FIG. 4 in view of FIG. 2A.

As shown in FIG. 2A, the display device 1 includes a display panel 11, a plurality of scan lines S1˜Sm, a plurality of data lines D1˜Dn, a scan driving circuit 12 and a data driving circuit 13. In addition, the display device 1 further includes a timing control circuit 14. The technical feature of the display device 1 have been described in the above, so it will not be repeated here. Of course, the driving method can also be applied to the above-mentioned display device 2.

The driving method of the display device includes a step S01 and a step S02.

The first step S01 is to conduct the scan lines S1˜Sm in order by the scan driving circuit 12. The second step S02 is to output a plurality of data signals corresponding to the data lines D1˜Dn by the data driving circuit 13 to drive the sub-pixels. Wherein, adjacent two of data signals of a first row sub-pixels are defined as a data signal pair, and the data signals of the first row sub-pixels are divided into a plurality of data signal pairs of the first row sub-pixels. The voltage polarity of each data signal pair is in a first arrangement or a second arrangement. The first arrangement has a positive polarity of the data signal and a negative polarity of the data signal with respect to a common voltage in order. The second arrangement has a negative polarity of the data signal and a positive polarity of the data signal with respect to the common voltage in order. A sequence of the voltage polarities of consecutive N data signals forms a cycle. Wherein, N is an even number greater than or equal to 10, and the amount of the first arrangement or the second arrangement in the cycle is greater than or equal to 1 and less than or equal to (N/2−1).

In one embodiment, the inversion mode of the voltage polarity of the data signals outputted by the data driving circuit 13 is stated as below. In one frame time, one data line outputs a plurality of data signals with the same voltage polarity (with respect to the common voltage) in order. In another embodiment, the driving method of the display device can be applied to the display device 2 (flip pixel array). In still another embodiment, since two spatially adjacent data signals form a data signal pair, the driving method of the display device can further apply with a charge sharing function so as to achieve the goal of the power saving. The charge sharing function is to temporarily short and conduct the amplifiers of two data lines, which connect to the same row of sub-pixels and have opposite voltage polarities, so as to neutralize the electricity to achieve the preset target voltage (data voltage). This procedure does not need to charge and discharge by the data driving circuit 13, so could improve the power consumption. The charge sharing cannot provide the pixel voltage to the target voltage directly, but it can make the pixel voltage to approach the target voltage. Then, the data driving circuit 13 outputs the data voltage to charge or discharge the pixel voltage through the data line, thereby achieving the desired target voltage.

In another embodiment, the driving method may further be applied with a scan pre-charge function, so that the sub-pixel can have better charging and discharging conditions (the voltage level of the sub-pixel is more precise). For example, one data line is corresponding to two sub-pixels A and B, and the sub-pixel A is charged first while the sub-pixel B is next. In the previous frame, the data line has charged the sub-pixel A to −3V and charged the sub-pixel B to −5V. In the current frame, the sub-pixel A is firstly charged to +3V due to the inversion. Due to the pre-charge design, the scan line connected to the sub-pixel B is turned on in advance. Accordingly, when the data line charges the sub-pixel A, the sub-pixel B will be also charged to the voltage of the sub-pixel A in the current frame (that is +3V). When the scan line connected to the sub-pixel A is turned off, the data line can then charge the sub-pixel from +3V to +5V. In this case, the two stages pre-charge method of the sub-pixel B (from −5V to +3V and then from +3V to +5V) can more precisely control the voltage level of the sub-pixel B than the one stage charging method (directly from −5V to +5V). As mentioned above, the pre-charging method must applied with the driving method that using one data line to output a plurality of voltages of the same polarity within a frame time.

The other technical features of the driving method of the display device have been described in the above embodiments, so the details are omitted.

To sum up, in the display device and driving method thereof of the disclosure, the data driving circuit outputs a plurality of data signals through the data lines to the sub-pixels. In spatial, two adjacent data signals of the first row sub-pixels are defined as a data signal pair, and the plurality of data signals of the first row sub-pixels are divided into a plurality of data signal pairs of the first row sub-pixels. The voltage polarity of each data signal pair is in a first arrangement or a second arrangement. Wherein, the data signals of the first arrangement has a positive polarity of the data signal and a negative polarity of the data signal with respect to a common voltage in order, while the second arrangement has a negative polarity of the data signal and a positive polarity of the data signal with respect to the common voltage in order. The voltage polarities of consecutive N data signals forms a cycle. Wherein, N is an even number greater than or equal to 10, and the amount of the first arrangement or the second arrangement in the cycle is greater than or equal to 1 and less than or equal to (N/−2−1). Compared with the conventional art, the display device of the disclosure utilizes an irregular polarity arrangement instead of the conventional column inversion, which provides a regular arrangement of periodical positive and negative voltage polarities for the spatially adjacent data signals. This change can improve the coupling level of the pixel electrodes and the common electrodes, Accordingly, the display device can have lower power consumption and improve the undesired display phenomenon such as flicker, crosstalk or display greenish.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display panel having a plurality of sub-pixels;
a plurality of scan lines;
a plurality of data lines intersected with the scan lines to define the sub-pixels, the sub-pixels comprise a first row sub-pixels;
a scan driving circuit electrically coupled with the scan lines; and
a data driving circuit electrically coupled with the data lines, wherein the data driving circuit outputs a plurality of data signals through each of the data lines to the sub-pixels, respectively;
wherein, adjacent two of the data signals of the first row sub-pixels are defined as a data signal pair, the plurality of data signals of the first row sub-pixels are divided into a plurality of the data signal pairs, a voltage polarity of each of the data signal pairs is in a first arrangement or a second arrangement, the first arrangement has a positive polarity of the data signal and a negative polarity of the data signal with respect to a common voltage in order, the second arrangement has a negative polarity of the data signal and a positive polarity of the data signal with respect to the common voltage in order,
wherein, a sequence of the voltage polarities of consecutive N data signals forms a cycle, N is an even number greater than or equal to 10, and an amount of the first arrangement or the second arrangement in the cycle is greater than or equal to 1 and less than or equal to (N/2−1).

2. The display device of claim 1, wherein one of the data lines outputs the plurality of data signals with the same voltage polarity in a frame time.

3. The display device of claim 1, wherein the voltage polarity of the data signals received by one of the sub-pixels in consecutive two frame times are opposite.

4. The display device of claim 2, wherein the sub-pixels are in flip pixel array.

5. The display device of claim 1, further comprising:
a memory coupled with the display panel for storing the sequence of the voltage polarities of the consecutive N data signals in the cycle.

6. The display device of claim 1, wherein the amount of the first arrangement and the amount of the second arrangement in the cycle are different.

7. The display device of claim 1, wherein the voltage polarity of the (N+1)th sub-pixel of the first row sub-pixels has the same voltage polarity with the first sub-pixel of the first row sub-pixels, and the voltage polarity of the (2N)th sub-pixel of the first row sub-pixels has the same voltage polarity with the Nth sub-pixel of the first row sub-pixels.

8. A driving method of a display device, the display device comprising a display panel, a plurality of scan lines, a plurality of data lines, a scan driving circuit and a data driving circuit, the display panel having a plurality sub-pixels, the sub-pixels comprise a first row sub-pixels, the data lines intersected with the scan lines to define the sub-pixels, the scan driving circuit electrically coupled with the scan lines, and the data driving circuit electrically coupled with the data lines, the driving method comprising steps of:
conducting the scan lines in order by the scan driving circuit; and
outputting a plurality of data signals corresponding to the data lines by the data driving circuit to drive the sub-pixels, wherein adjacent two of the data signals of the first row sub-pixels are defined as a data signal pair, the data signals are divided into a plurality of the data signal pairs of the first row sub-pixels, a voltage polarity of each of the data signal pairs is in a first arrangement or a second arrangement, the first arrangement has a positive polarity of the data signal and a negative polarity of the data signal with respect to a common voltage in order, the second arrangement has a negative polarity of the data signal and a positive polarity of the data signal with respect to the common voltage in order, a sequence of voltage polarities of consecutive N data signals forms a cycle, N is an even number greater than or equal to 10, and an amount of the first arrangement or the second arrangement in the cycle is greater than or equal to 1 and less than or equal to (N/2−1).

9. The driving method of claim 8, wherein one of the data lines outputs the plurality of data signals with the same voltage polarity in a frame time.

10. The driving method of claim 9, wherein the sub-pixels are in a flip pixel array.

11. The driving method of claim 8, which is further applied with a charge sharing function.

12. The driving method of claim 8, which is further applied with a scan pre-charge function.
